(19) United States
(12) Patent Application Publication
(10) Pub. No.: US 2020/0407599 A1
(43) Pub. Date: Dec. 31, 2020

(54) ADHESIVE CABLE-WRAPPING TAPE

(71) Applicant: CERTOPLAST TECHNISCHE KLEBEBÄNDER GMBH, Wuppertal (DE)

(72) Inventor: Timo LEERMANN, Wuppertal (DE)

(21) Appl. No.: 16/975,253

(22) PCT Filed: Feb. 27, 2019
(86) PCT No.: PCT/EP2019/054895

§ 371 Date: Aug. 24, 2020

(30) Foreign Application Priority Data
Mar. 14, 2018 (DE) 20 2018 101 435.8

(51) Int. Cl. C09J 7/29; D03D 1/00; D03D 13/00; D03D 11/00; D03D 15/00; D03D 15/08; C09J 133/00; C09J 7/38; C09J 7/21; H01B 7/18

(52) U.S. Cl. CPC C09J 7/29; C09J 2203/302; D03D 13/004; D03D 11/00; D03D 15/0027; D03D 15/08; C09J 133/00; C09J 7/385; C09J 7/21; H01B 7/1865; H01B 7/1855; D10B 2321/0211; D10B 2331/02; D10B 2331/04; D03D 2700/0111; D03D 2700/0174; C09J 2477/006; C09J 2467/006; C09J 2433/00; C09J 2423/046; C09J 2421/006; C09J 2400/263; C09J 2301/302; D03D 1/0041

(57) ABSTRACT

The subject matter of the invention is an adhesive tape, in particular a wrapping tape for sheathing cables in automobiles. The tape has a fabric backing (1, 3, 2, 4) in the form of a monoweave and an adhesive coating (7) on at least one side of the backing (1, 3, 2, 4). According to the invention, the monoweave is at least three-ply, and abrasion-resistant, non-connected warp threads (1, 3) form an outer layer and an inner layer. An intermediate layer made of weft threads (2, 4) is provided, the bonding points (5) of said layer coinciding with those of the outer layer and not with the bonding points (6) of the inner layer.

The invention relates to an adhesive tape, in particular a tape for wrapping motor-vehicle cables, with an abrasion-resistant textile backing formed by a monoweave, and with an adhesive coating on at least one face of the backing.

Requirements for adhesive tapes, and in particular wrapping tapes for sheathing motor-vehicle cables, result not only from the fact that particular media resistance to for example oil and gasoline is required, but also that great temperature resistance is required. In fact, wrapping tapes of this type should be able to be used in the range between minus 50° C. or minus 40° C. up to plus 150° C. and more. Furthermore, low acoustic emissions are aimed for, for example in such a way that rattling noises of a cable harness or cable branch that is thus wrapped are prevented as far as possible.

Furthermore, high abrasion resistance is required for such wrapping tapes, as is described in detail for example in the prior art according to WO 2005/085379 [U.S. Pat. No. 8,815,389]. The abrasion resistance in this case can be determined based on the standard LV 312. In order to achieve high abrasion resistance, a laminate structure is proposed in the prior art that is composed of a first cover layer, a second cover layer and an intermediate layer connecting the two cover layers. This is complex in terms of manufacture.

Furthermore, a fabric adhesive tape with high abrasion resistance that can be torn crosswise is known from EP 2 322 385 [U.S. Pat. No. 9,611,408]. In this case, the yarn size in dtex of the weft yarns is designed to be greater than the yarn size in dtex of the warp yarns.

In this manner, sufficient bond strength of the backing fabric should be achieved. Furthermore, good hand tearing ability in the direction of the weft yarns should still be ensured. At the same time, the weft yarns are equipped with an abrasion resistance in accordance with the class greater than or equal to C and in particular D according to LV 312 (2009), as is described in detail therein.

The known adhesive tape or wrapping tape corresponding to EP 2 322 385 may well altogether have the abrasion resistance necessary for applications in the automobile sector. The fact that the warp and weft yarns may be made from polyester also contributes to this. Alternatively, weft yarns made of polyamide are also conceivable. However, recent requirements in relation to cut resistance are not, or not sufficiently, met. In fact, nowadays in addition to the requirements described above, an increased cut resistance or alternatively impact resistance is required for adhesive tapes in motor vehicles, as is the subject of LV 312-3 (2009). Such requirements in relation to impact resistance or alternatively cut resistance result inter alia from the fact that motor vehicles nowadays often have components that are operated purely electrically, such as for example door locks.

If for example a side impact occurs with a motor vehicle constructed in this way, there is the risk that electric supply lines for the door locks in question will be cut off by the side impact, so that rescuers arriving cannot free the occupants in the vehicle, or can free them only with difficulty, because first of all the associated door has to be opened by force to do this. At any rate, nowadays there are increasing requirements for the electric power supply, in particular following an accident, to be maintained or to be able to still be ensured at least for a certain time. This requires adhesive tapes, and in particular wrapping tapes for sheathing motor-vehicle cables that have increased cut resistance or impact resistance, which is not provided by previous embodiments.

Accordingly, the object of the present invention is to develop further an adhesive tape of this type, and in particular tape for wrapping motor-vehicle cables, such that not only the necessary abrasion resistance is observed, but also an increased cut resistance or impact resistance compared with the prior art.

To attain this object, a generic adhesive tape in the context of the invention is characterized in that the monoweave is at least three-ply with non-connected warp yarns that form both an outer layer and an inner layer, and an intermediate layer made of weft yarns whose binding points with the outer layer do not coincide with binding points of the inner layer.

In the context of the invention, therefore, first and foremost use is made of a monoweave, i.e. a woven fabric that in the present case is constructed from three layers, but overall defines a single woven fabric. In this case, both the outer and the inner layer of the woven fabric are formed by non-connected warp yarns that in conjunction with the protective yarns are designed to be abrasion-resistant overall. That is to say, both the inner layer of the woven fabric and the outer layer of the woven fabric comply with at least abrasion class C according to LV 312-1 (2009). In particular, the two layers of the woven fabric even meet at least class D according to LV 312-1. The invention advantageously achieves this in that for example warp yarns made of PE (polyethylene), in particular of what is called UHMWPE (ultra-high-molecular-weight polyethylene), are used as warp yarns. Such fibers or yarns are known inter alia under the brand name “Dyneema” and have tensile strengths of 3 to 4 GPa. Furthermore, fineness-related maximum tensile forces for such UHMWPE yarns of at least 30 cN/dtex are observed. The weft yarns may be constructed from an identical material. In general, the weft yarns are however entirely or partly made from an elastomer.

Furthermore, it has proven useful if the warp yarns are made from polyamide (PA) or alternatively polyester (PET). Something comparable applies to the weft yarns. Mixed forms are also conceivable. Further, the yarns are designed to be cut-resistant at the same time. In fact, altogether an impact-resistant layer corresponding to the standard LV 312-3 (2009) of the woven fabric can be realized. This applies both to the inner layer and to the outer layer. The yarns, that is to say the warp yarns and/or weft yarns, may also be bicomponent yarns.

In this case, the bicomponent yarns in question have a yarn core of for example UHMWPE or alternatively of polyamide that has an outer coating with natural fibers, cellulose fibers or alternatively fire-resistant or refractory fibers.

The number of warp yarns in the monoweave according to the invention in question may be between 8 warp yarns/cm and 50 warp yarns/cm. Similar yarn counts of between 8/cm and 50/cm are also observed for the weft yarns. In fact, even up to 70 weft yarns/cm can be realized. In contrast to the abrasion-resistant warp yarns, the weft yarns are advantageously made entirely or partially from an elastomer. The weft yarns may also be designed overall as bicomponent yarns.

In this case, the invention for the weft yarns again relies on a yarn core made of for example UHMWPE, polyamide or alternatively polyester, as is basically used also for the warp yarns. The weft yarns that are designed as bicomponent yarns are then still covered with natural cellulosic or synthetic fibers as elastomeric fibers that impart a certain elasticity to the weft yarns. In this connection, it has furthermore proved useful if the weft yarns are connected with the warp yarns by a twill weave.

The yarns of the monoweave, i.e. both the warp yarns and the weft yarns, as a rule have a fineness of at least 100 dtex. Usually, even a fineness of at least 150 dtex and more is observed. The weight per unit area of the backing made from the monoweave that is realized in this manner may be between 50 g/m² and 300 g/m².

For the adhesive coating that is applied to the backing at least on one face, the invention advantageously recommends a contact adhesive that for example may be a rubber, acrylate or silicone adhesive. In principle, of course other adhesives are also conceivable that are applied to the backing for example as a dispersion or from the melt. The invention recommends values in the range from 50 g/m² to 200 g/m² as the grammage for the adhesive coating.

The adhesive tape made available in this manner may in principle be designed as wrapping tape that is guided in a spiral or helix around cable bundles.

Alternatively, longitudinal sheathing can also be realized with the aid of the adhesive tape. In this case, the adhesive tape is applied in the longitudinal direction around the cables that are to be sheathed.

As a result, an adhesive tape with a novel monoweave as backing is made available. The three-ply structure realized at this point, in particular with the non-connected abrasion-resistant warp yarns, in combination with the elastic weft yarns forming the intermediate layer, overall leads to not only a high abrasion resistance, but also a particular cut resistance and impact resistance being observed that meet the requirements in particular according to LV 312-3 (2009).

This can basically be attributed to the fact that the outer layer when subjected to a cutting load or when testing for impact resistance initially acts as a first protection or armoring. Primarily the warp yarns forming the outer layer ensure this. In fact, the outer layer has special abrasion protection. Additionally, the inner layer, which is not connected to the outer layer, ensures more extensive protection. This is because the associated warp yarns of the inner layer can to a certain degree move relative to the warp yarns of the outer layer, and shock or impact stresses are thereby not transmitted directly to the inner layer. Overall, the intermediate layer made of the advantageously elastic weft yarns ensures this mutual decoupling.

Due to the elasticity described and the associated resilience of the monoweave according to the invention, in a certain manner adaptation to the striking tool or to impacting edges occurs, so that high abrasion resistance and also increased tear and cutting resistance is observed.

In addition, the adhesive tape according to the invention with the specially designed monoweave is equipped overall with an increased number of yarns per cm² compared with previous single-layer woven fabrics. In fact, overall up to 50 warp yarns per cm and at least as many weft yarns per cm are observed, so that the number of yarns per cm² is considerably higher compared with for example the monolayer woven fabric of EP 2 322 385 A1. As a result, the desired high abrasion protection in conjunction with the increased cut resistance is observed. This is where the essential advantages can be seen.

The invention will be discussed in greater detail below with reference to drawings that illustrate merely one embodiment in which:

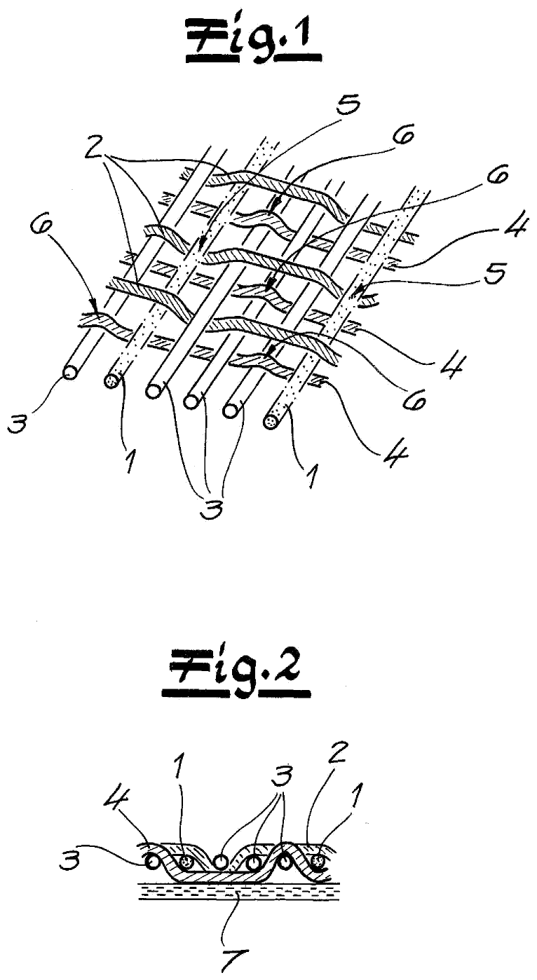

FIG. 1 schematically shows the adhesive tape according to the invention, and

FIG. 2 is a section through the object of FIG. 1.

The drawing shows an adhesive tape composed of an abrasion-resistant textile backing 1, 3, 2, 4 formed by a monoweave. The textile backing 1, 3, 2, 4 has an adhesive coating 7. The adhesive coating 7 as a rule is on the inner face of the textile backing 1, 3, 2, 4 when wound for example around one or more cables.

The abrasion-resistant textile backing 1, 3, 2, 4 is formed overall as a monoweave. In turn, this monoweave has three layers traversed by abrasion-resistant warp yarns 1 and 3. The warp yarns 1 and 3 are not connected directly to one another. In fact, FIG. 1 shows that first warp yarns 1 define an outer layer. Furthermore, the warp yarns 3 form an inner layer of the monoweave or of the textile backing 1, 3, 2, 4.

The warp yarns 1 and 3 are retained in the monoweave or the textile backing 1, 3, 2, 4 by weft yarns 2 and 4. To this end, in the context of the embodiment and non-restrictively, the weft yarns 2 and 4 are connected with the warp yarns 1 and 3 in a twill weave. Such a twill weave is distinguished in that each weft yarn 2, 4 passes under a single warp yarn 1 or 3 and thereafter over at least two warp yarns 1 or 3.

If for example the middle weft yarn 2 of FIG. 1 is considered, it initially passes through under the warp yarn 1 of the outer layer that can be recognized on the right in FIG. 1. Thereafter, the weft yarn 2 passes over at least two inner warp yarns 3, in the present case over three inner warp yarns 3. Thereafter, the weft yarn 2 again passes under the next outer warp yarn 1. Thus the middle weft yarn 2 and the adjacent weft yarns 2 are offset from one another. At any rate, in this manner binding points 5 with the outer layer or the outer warp yarns 1 are formed for the weft yarns 2.

The weft yarns 4 additionally provided in contrast lead to further binding points 6 with the inner layer or the inner warp yarns 3. The binding points 5 and 6 do not coincide, or are offset from one another. That is to say, the binding points 5, 6 are oriented such that one binding point 5, 6 of the intermediate layer or of the weft yarns 2 and 4 with the outer layer or the outer warp yarns 1 that is to say in the present case the binding points 5, never coincide with the position of the binding point 6 of the intermediate layer or of the weft yarns 2 and 4 with the inner layer or the inner warp yarns 3. As a result, separation of the warp yarns 1 and 3 from each other occurs, because namely the outer warp yarns 1 can be distinguished from the inner warp yarns 3. In conjunction with the additional elasticity of the weft yarns 2 and 4, as a result to a certain extent of elastic movement of the warp yarns 1 or 3 relative to each other are possible.

In fact, in the present case the warp yarns 1 and 3 are manufactured from for example PE, PA, PET, as has already been described above. Furthermore, the warp yarns 1 and 3, just like the weft yarns 2 and 4, may be bicomponent yarns, as was discussed above. In this manner, as a rule both the outer layer and the inner layer are made abrasion-resistant, and namely achieve at least abrasion class C according to LV 312-1 (2009). In particular, the outer layer and/or inner layer even comply with class D according to 312-1. Furthermore, both layers are, or at least the outer layer is, impact-resistant corresponding to the standard LV 312-3 already mentioned previously.

The weft yarns 2 and 4 are made entirely or partially from an elastomer. Furthermore, the above-described twill weave is seen between the weft yarns 2 and 4 and the warp yarns 1 and 3 in the illustrated embodiment. The yarns 1, 3, 2, 4 of the monoweave in general have a fineness of at least 100 dtex. Furthermore, the weight per unit area of the backing 1, 3, 2, 4 realized in this manner is in the range from 50 g/m² to 300 g/m².

The number of warp yarns 1 and 3 may be between 8/cm and 50/cm. The number of weft yarns 2 and 4 may be designed to be from 8/cm up to 70/cm, so that overall the yarn density per cm² in the textile backing 1, 3, 2, 4 according to the invention is considerably higher than with the monoweave according to EP 2 322 385 that forms the point of departure.

Finally, the adhesive coating 7 is advantageously a contact adhesive for example also of acrylate basis that can be applied to the backing 1, 3, 2, 4 in question by hot-melt coating. This of course applies only for example and is in no way limiting.

1. In an adhesive tape for wrapping motor-vehicle cables and having:
a textile backing formed by a monoweave, and
an adhesive coating on at least one face of the backing,
the improvements wherein:
the monoweave is at least three-ply and formed by
non-connected abrasion-resistant warp yarns forming both an outer layer and an inner layer, and
weft filaments forming an intermediate layer whose binding points with the outer layer do not coincide with binding points with the inner layer.

2. The adhesive tape according to claim 1, wherein the abrasion-resistant warp yarns are made from PE, PA or PET.

3. The adhesive tape according to claim 1, wherein the abrasion-resistant warp yarns are also cut-resistant.

4. The adhesive tape according to claim 1, wherein the abrasion-resistant warp yarns are bicomponent yarns.

5. The adhesive tape according to claim 1, wherein the weft yarns are made entirely or partially from an elastomer.

6. The adhesive tape according to claim 1, wherein the weft yarns are connected with the warp yarns in a twill weave.

7. The adhesive tape according to claim 1, wherein the warp and weft yarns of the monoweave have a fineness of at least 100 dtex, in particular a fineness of at least 150 dtex.

8. The adhesive tape according to claim 1, wherein the weight per unit area of the backing is between 50 g/m² and 300 g/m².

9. The adhesive tape according to claim 1, wherein the adhesive coating is formed by a contact adhesive based on acrylate.
